(19) United States
(12) Patent Application Publication
(10) Pub. No.: US 2015/0078744 A1
(43) Pub. Date: Mar. 19, 2015

(54) MULTIPLEXED OPTICAL TRANSMISSION LINE, OPTICAL TRANSMISSION SYSTEM, AND OPTICAL TRANSMISSION METHOD

(71) Applicant: NEC Corporation, Minato-ku, Tokyo (JP)

(72) Inventors: Toshiharu Ito, Tokyo (JP); Manabu Arikawa, Tokyo (JP); Emmanuel Le Taillandier De Gabory, Tokyo (JP)

(21) Appl. No.: 14/390,471

(22) PCT Filed: Apr. 16, 2013
(86) PCT No.: PCT/JP2013/002552

§ 371 Date: Oct. 3, 2014

(30) Foreign Application Priority Data
Apr. 20, 2012 (JP) 2012-096896

(51) Int. Cl. H04B 10/25

(52) U.S. Cl. CPC H04B 10/2503
USPC 398/43

(57) ABSTRACT

It is difficult in an optical transmission system using a multicore optical fiber to provide high-capacity transmission in which good signal quality is obtained, therefore, a multiplexed optical transmission line according to an exemplary aspect of the present invention includes at least one first optical transmission line propagating first signal light in a first direction; and at least one second optical transmission line propagating second signal light in a second direction opposite to the first direction, wherein the second optical transmission line is disposed in at least one of positions adjacent to the first optical transmission line wherever the first optical transmission line may be disposed.

### TECHNICAL FIELD

The present invention relates to multiplexed optical transmission lines, optical transmission systems, and optical transmission methods and, in particular, to a multiplexed optical transmission line, an optical transmission system, and an optical transmission method used for a high-capacity optical communication.

### BACKGROUND ART

In a backbone long-haul and high-capacity optical fiber transmission system supporting the Internet, the technology to improve a capacity capable of transmission through one optical fiber has been developed in order to respond to increased demand for a transmission capacity. Until now, in order to improve a transmission capacity, a technique improving a transmission speed, that is, “time multiplexing” technique has been used. It is difficult, however, to deal with a dramatic increase in the transmission capacity due to the spread of the Internet by using the time multiplexing technique only. Therefore, a combination of techniques, which utilize the property of an optical fiber, of “wavelength multiplexing”, “waveband multiplexing” and “polarization multiplexing” has made it possible to deal with the increased demand for the transmission capacity. By an accumulation of such technical development, possible transmission capacity per one fiber has reached a level beyond 100 terabits/second on the demonstration level. It is difficult, however, to achieve any further significant improvement as an extension of the present technology.

As a technique enabling a further increase in the transmission capacity, “spatial multiplexing” technique has received attention. There are a plurality of methods for the “spatial multiplexing” technique. First, there is a “fiber multiplexing” method which can increase the total transmission capacity N times by using N optical fibers in parallel. And there are a “mode multiplexing” method which uses respective waveguide modes of a multimode fiber independently, a “core multiplexing” method which independently uses respective cores of a multicore optical fiber including a plurality of cores in one fiber (refer to Non Patent Literature 1, for example), and the like. Especially, in a demonstration of high-capacity optical transmission using the “core multiplexing” method, the possible transmission capacity beyond 100 terabits/second per one fiber has been achieved.

Patent Literature 1 describes an example of an optical transmitter and receiver module which enables bidirectional optical communications using only one plastic optical fiber by the “core multiplexing” method. The optical transmitter and receiver module in Patent Literature 1 is connected so that a light emitting element and a light receiving element may be located within the range of the diameter of a multicore plastic optical fiber. It is configured to transmit the transmission light emitted from the light emitting element through one or more core among a plurality of cores included in the optical fiber using one multicore plastic optical fiber, and for the receiving light transmitted through one or more core different from the core to enter the light receiving element. It is said that such configuration makes it possible to achieve highly reliable bidirectional optical communications with long transmission distance by one plastic optical fiber without being affected by light reflection at the end of the plastic optical fiber.

### CITATION LIST

### Patent Literature

### [PTL 1]

Japanese Patent Application Laid-open Publication No. 2001-242348 (paragraphs [0032] to [0054])

### [Non Patent Literature]

[NPL 1] K. Imamura, K. Mukasa, and T. Yagi, “Investigation on Multi-Core Fibers with Large Aeff and Low Micro Bending Loss,” in Optical Fiber Communication Conference, OSA Technical Digest (CD) (Optical Society of America, 2010), paper OWK6.

### SUMMARY OF INVENTION

### Technical Problem

In the core multiplexing method mentioned above, since a multi core optical fiber with N cores is used, it is possible to increase the transmission capacity per optical fiber N times. There is a problem, however, that the signal quality is degraded due to a crosstalk occurring between cores. For example, in the multi core optical fiber described in Non Patent Literature 1, a crosstalk of about −20 dB occurs after 2 km transmission. This crosstalk degrades the signal quality in the optical transmission system using the related multicore optical fiber.

In order to reduce the amount of a crosstalk in a multicore optical fiber, it can be considered to suppress the amount of the light leaking from a core, for example. However, this requires strengthening the optical confinement into a core, which results in a factor increasing non-linear degradation. In addition, when the distance between cores is expanded in order to reduce the amount of the crosstalk, this becomes a factor for limiting the number of cores arranged in one fiber. That is to say, if it is intended to reduce the amount of the crosstalk in a multicore optical fiber, this conflicts with the demand for transmission lines for a high-capacity transmission system.

In this way, there has been a problem that it is difficult in an optical transmission system using a multicore optical fiber to provide high-capacity transmission in which good signal quality is obtained.

The object of the present invention is to provide a multiplexed optical transmission line, an optical transmission system, and an optical transmission method that solve the problem mentioned above that it is difficult in an optical transmission system using a multicore optical fiber to provide high-capacity transmission in which good signal quality is obtained.

### Solution to Problem

A multiplexed optical transmission line according to an exemplary aspect of the present invention includes at least one first optical transmission line propagating first signal light in a first direction; and at least one second optical transmission line propagating second signal light in a second direction opposite to the first direction, wherein the second optical transmission line is disposed in at least one of positions adjacent to the first optical transmission line wherever the first optical transmission line may be disposed.

An optical transmission system according to an exemplary aspect of the present invention includes a multiplexed optical transmission line; a first optical transmitter and a first optical receiver connected to a first end of the multiplexed optical transmission line; and a second optical transmitter and a second optical receiver connected to a second end on the side opposite to the first end of the multiplexed optical transmission line, wherein the multiplexed optical transmission line includes at least one first optical transmission line propagating first signal light in a first direction; and at least one second optical transmission line propagating second signal light in a second direction opposite to the first direction, wherein the second optical transmission line is disposed in at least one of positions adjacent to the first optical transmission line wherever the first optical transmission line may be disposed,

wherein the first optical transmitter is connected to the first optical transmission line at the first end, the second optical receiver is connected to the first optical transmission line at the second end, the second optical transmitter is connected to the second optical transmission line at the second end, and the first optical receiver is connected to the second optical transmission line at the first end.

An optical transmission method according to an exemplary aspect of the present invention includes disposing at least one first optical transmission line and at least one second optical transmission line so as to locate the second optical transmission line in at least one of positions adjacent to the first optical transmission line wherever the first optical transmission line being disposed; propagating first signal light in a first direction through the first optical transmission line; and propagating second signal light in a second direction opposite to the first direction through the second optical transmission line.

### Advantageous Effects of Invention

According to the multiplexed optical transmission line, the optical transmission system, and the optical transmission method of the present invention, it is possible in an optical transmission system using a multicore optical fiber as a multiplexed optical transmission line to realize high-capacity transmission in which good signal quality is obtained.

### BRIEF DESCRIPTION OF DRAWINGS

FIG. 1 is a schematic diagram illustrating a configuration of an optical transmission system using a multiplexed optical transmission line in accordance with the first exemplary embodiment of the present invention.

FIG. 2 is a schematic diagram illustrating a configuration of an optical transmission system using a related multicore optical fiber.

FIG. 3 is a diagram illustrating calculation results of optical transmission characteristics in a multicore optical fiber.

FIG. 4 is a schematic diagram to describe a crosstalk in the multiplexed optical transmission line in accordance with the first exemplary embodiment of the present invention.

FIG. 5 is a cross-sectional view illustrating a configuration of a multiplexed optical transmission line in accordance with the second exemplary embodiment of the present invention.

FIG. 6 is a cross-sectional view illustrating another configuration of the multiplexed optical transmission line in accordance with the second exemplary embodiment of the present invention.

FIG. 7A is a cross-sectional view illustrating still another configuration of the multiplexed optical transmission line in accordance with the second exemplary embodiment of the present invention.

FIG. 7B is a cross-sectional view illustrating still another configuration of the multiplexed optical transmission line in accordance with the second exemplary embodiment of the present invention.

FIG. 8A is a cross-sectional view illustrating still another configuration of the multiplexed optical transmission line in accordance with the second exemplary embodiment of the present invention.

FIG. 8B is a cross-sectional view illustrating still another configuration of the multiplexed optical transmission line in accordance with the second exemplary embodiment of the present invention.

FIG. 9A is a cross-sectional view illustrating a configuration of a multiplexed optical transmission line in accordance with the third exemplary embodiment of the present invention.

FIG. 9B is a cross-sectional view illustrating the configuration of the multiplexed optical transmission line in accordance with the third exemplary embodiment of the present invention.

### DESCRIPTION OF EMBODIMENTS

The exemplary embodiments of the present invention will be described with reference to drawings below.

### The First Exemplary Embodiment

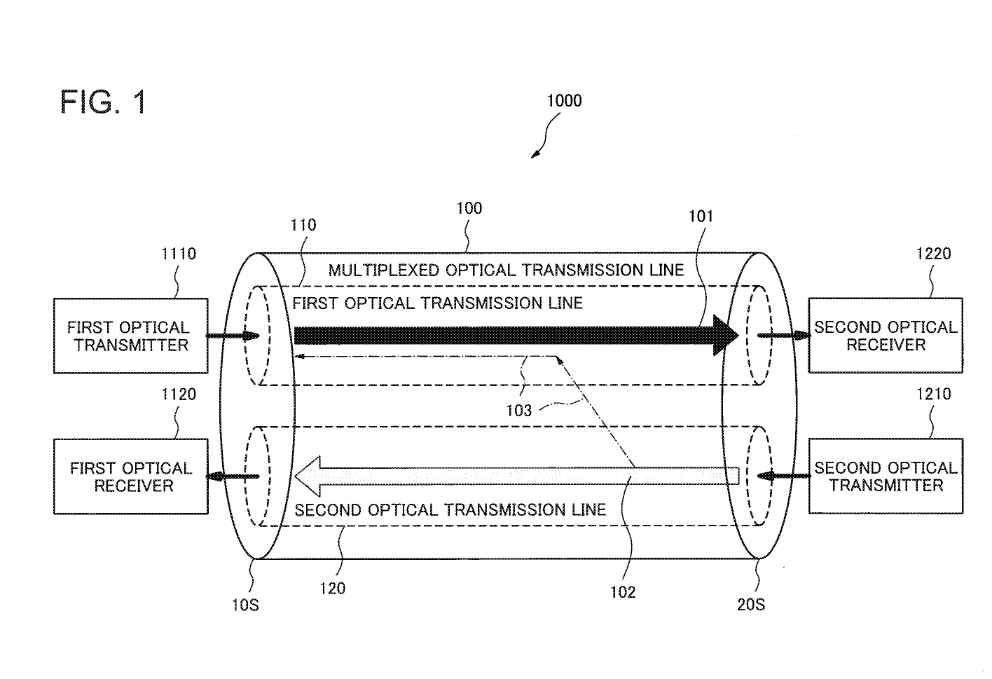

FIG. 1 is a schematic diagram illustrating a configuration of an optical transmission system 1000 using a multiplexed optical transmission line 100 in accordance with the first exemplary embodiment of the present invention. The multiplexed optical transmission line 100 includes at least one first optical transmission line 110 and at least one second optical transmission line 120. The first optical transmission line 110 propagates first signal light 101 in a first direction. On the other hand, the second optical transmission line 120 propagates second signal light 102 in a second direction opposite to the first direction. The multiplexed optical transmission line 100 is configured to dispose the second optical transmission line 120 in at least one of positions adjacent to the first optical transmission line 110 wherever the first optical transmission line 110 may be disposed.

A multicore optical fiber can be used as the multiplexed optical transmission line 100 may be which includes in one optical fiber a plurality of cores composing optical transmission lines, for example. In this case, the propagation direction of the signal light is allocated to each core. There is a mixture of a core propagating signal light in the first direction and a core propagating signal light in the second direction opposite to the direction at positions adjacent to each other in one multicore optical fiber. FIG. 1 illustrates a case in which one of the first optical transmission lines 110 (core A) and one of the second optical transmission lines 120 (core B) are included.

The optical transmission system 1000 is configured by connecting an optical transmitter and an optical receiver to both ends of the multiplexed optical transmission line 100, respectively. That is to say, a first optical transmitter 1110 and a first optical receiver 1120 are connected to a first end 10S (left edge of FIG. 1) of the multiplexed optical transmission line 100. On the other hand, a second optical transmitter 1210 and a second optical receiver 1220 are connected to a second end 20S (right edge of FIG. 1) on the side opposite to the first end 10S of the multiplexed optical transmission line 100.

In this case, the first optical transmitter 1110 is connected to the first optical transmission line 110 at the first end 105, and the second optical receiver 1220 is connected to the first optical transmission line 110 at the second end 205. The second optical transmitter 1210 is connected to the second optical transmission line 120 at the second end 205, and the first optical receiver 1120 is connected to the second optical transmission line 120 at the first end 105.

As illustrated in the same diagram, the propagation directions of the first signal light 101 and the second signal light 102 propagated by the first optical transmission line 110 (core A) and the second optical transmission line 120 (core B), respectively, differ from each other. Therefore, crosstalk component light 103 due to the fact that a part of the second signal light 102 leaks from the second optical transmission line 120 (core B) to the first optical transmission line 110 (core A) propagates in the direction opposite to the first signal light 101 propagating in the first optical transmission line 110 (core A). Accordingly, when the first signal light 101 propagating through the first optical transmission line 110 (core A) is received by the second optical receiver 1220, the crosstalk component light 103 has no influence.

Hence, according to the multiplexed optical transmission line 100 of the present exemplary embodiment, it is possible in an optical transmission system using a multicore optical fiber as a multiplexed optical transmission line to realize high-capacity transmission in which good signal quality is obtained. As a result, it becomes possible to prolong the transmission distance in the optical transmission system.

In an optical transmission method in accordance with the present exemplary embodiment, first, at least one first optical transmission line and at least one second optical transmission line are disposed. At this time, they are disposed so that the second optical transmission line may be located in at least one of positions adjacent to the first optical transmission line wherever the first optical transmission line 110 may be disposed. Then, first signal light is propagated in a first direction through the first optical transmission line, and a second signal light is propagated in a second direction opposite to the first direction through the second optical transmission line. Hence, it is possible in an optical transmission system using a multicore optical fiber as a multiplexed optical transmission line to realize high-capacity transmission in which good signal quality is obtained.

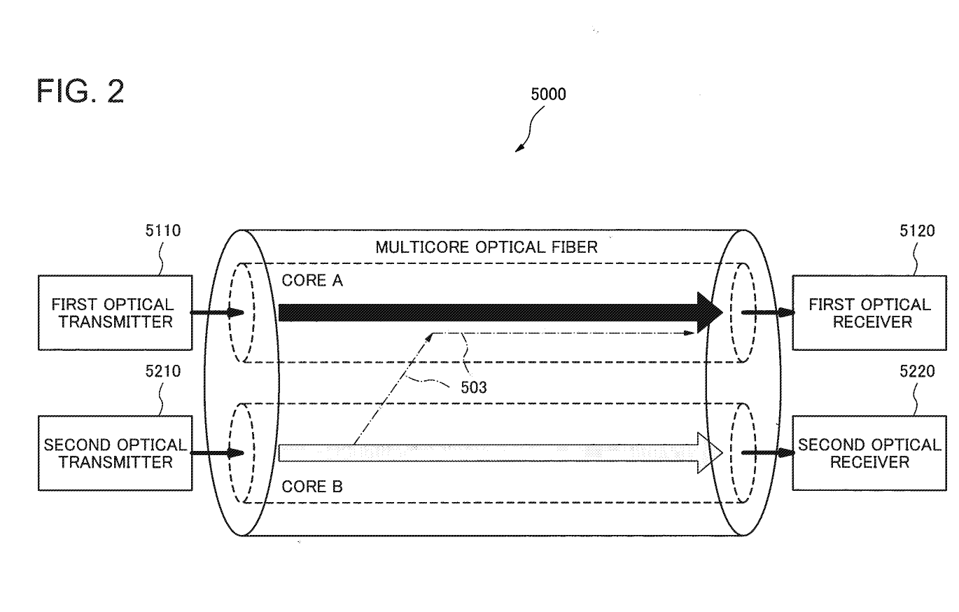

Next, the function and effect of the multiplexed optical transmission line 100 in accordance with the present exemplary embodiment will be described further in detail. FIG. 2 illustrates a schematic diagram of a related optical transmission system 5000 using a multicore optical fiber.

It is necessary to propagate the signal light interactively in the optical fiber transmission system. Therefore, in a conventional optical transmission system using a single core optical fiber, the system is configured by using two optical fibers and allocating one direction to each optical fiber. When a multicore optical fiber is used, in a related optical transmission system, the optical transmission system is similarly configured by using two optical fibers and allocating all of the signal light in one optical fiber so as to propagate in the same direction.

FIG. 2 is a schematic diagram illustrating a configuration of a related optical transmission system 5000 in which the propagation direction of signal light propagating through a core A is the same as that propagating through a core B. In this case, a crosstalk component 503 of the signal light leaking from the core B to the core A propagates in the same direction as the signal light propagating in the core A. Therefore, when the signal light propagating through the core A is inputted into the first optical receiver 5120, the crosstalk signal light 503 from the core B is also inputted simultaneously. This is the factor by which the signal quality deteriorates in the related optical transmission system using the multicore optical fiber.

In contrast, in the multiplexed optical transmission line 100 in accordance with the present exemplary embodiment, each optical transmission line (core) disposed in a multiplexed optical transmission line (a multicore optical fiber) is configured so that the second optical transmission line may be disposed in at least one of positions adjacent to the first optical transmission line. Therefore, it does not occur that the signal light propagates in the same direction in all adjacent optical transmission lines (cores). This makes it possible to reduce effects of the crosstalk which occurs.

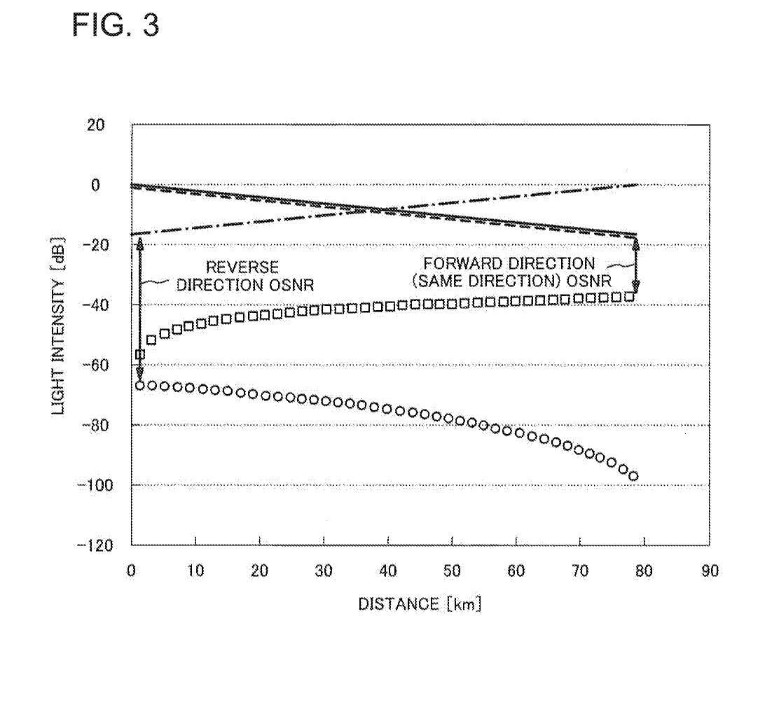

FIG. 3 illustrates calculation results of optical transmission characteristics in a multicore optical fiber including the core A and the core B. The vertical axis of the diagram represents light intensity, and the horizontal axis represents transmission distance. In the diagram, a solid line represents the signal light intensity in the core A, a dashed line represents the signal light intensity in the core B propagating in the forward direction (the same direction as the propagation direction of the signal light in the core A), and a dashed-dotted line represents the signal light intensity in the core B propagating in the reverse direction (the direction reverse to the propagation direction of the signal light in the core A).

A symbol “∘” represents the amount of generated crosstalk when the transmission direction in the core A is the direction reverse to that in the core B (see FIG. 1) as is the case with the multiplexed optical transmission line in accordance with the present exemplary embodiment. A symbol “□” represents the amount of generated crosstalk when the transmission direction in the core A and the core B is the forward direction (see FIG. 2) as is the case with the related multicore optical fiber. It is assumed in the calculations that the amount of generated crosstalk per unit length leaking from the core B to the core A is equal to −40 dB/km and the amount of generated reflection per unit length in the core is equal to −50 dB/km.

FIG. 3 shows that the optical signal-to-noise ratio (OSNR) at the end of the receiving side (the end of the span) of the multiplexed optical transmission line is significantly improved by about 29.5 dB in the configuration to transmit in the reverse direction compared to the configuration to transmit in the same direction.

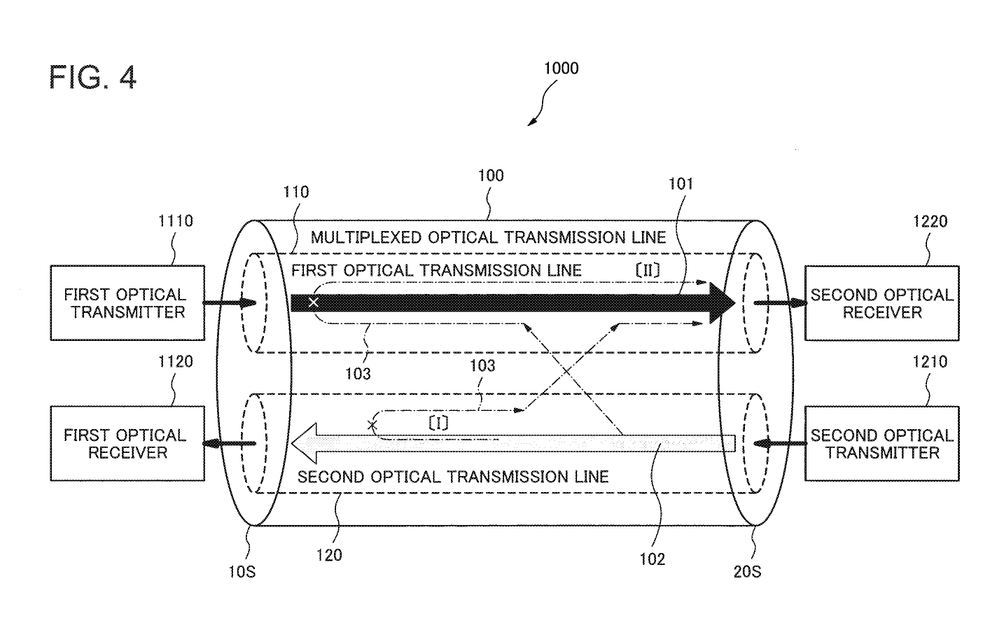

Next, further description will be made using FIG. 4 on the crosstalk in the case where the propagation direction of the signal light propagating through the first optical transmission line 110 (core A) is different from that of the signal light propagating through the second optical transmission line 120 (core B) as the multiplexed optical transmission line 100 in accordance with the present exemplary embodiment.

Description will be made on two special cases in which the crosstalk component light 103 due to the fact that part of second signal light 102 leaks from the second optical transmission line 120 (core B) to the first optical transmission line 110 (core A) can become degrading factors of the signal quality. The first ([I] in FIG. 4) is a case where the crosstalk component light 103 leaking from the core B to the core A arises after the second signal light 102 starts to propagate in the opposite direction due to being reflected in the second optical transmission line 120 (core B). The second ([II] in FIG. 4) is a case where the crosstalk component light 103 leaking from the second optical transmission line 120 (core B) to the first optical transmission line 110 (core A) arises, and then the crosstalk component light 103 is reflected in the first optical transmission line 110 (core A).

As the reflection becoming a factor for such reverse propagation, two kinds of reflection, that is, the Fresnel reflection occurring at a non-ideal optical connector or a fusion point, and the Rayleigh reflection in an optical fiber, can be considered. However, since those kinds of reflection are suppressed to a negligible level in conventional optical transmission systems, they do not affect the effect of the multiplexed optical transmission line 100 in accordance with the present exemplary embodiment.

### The Second Exemplary Embodiment

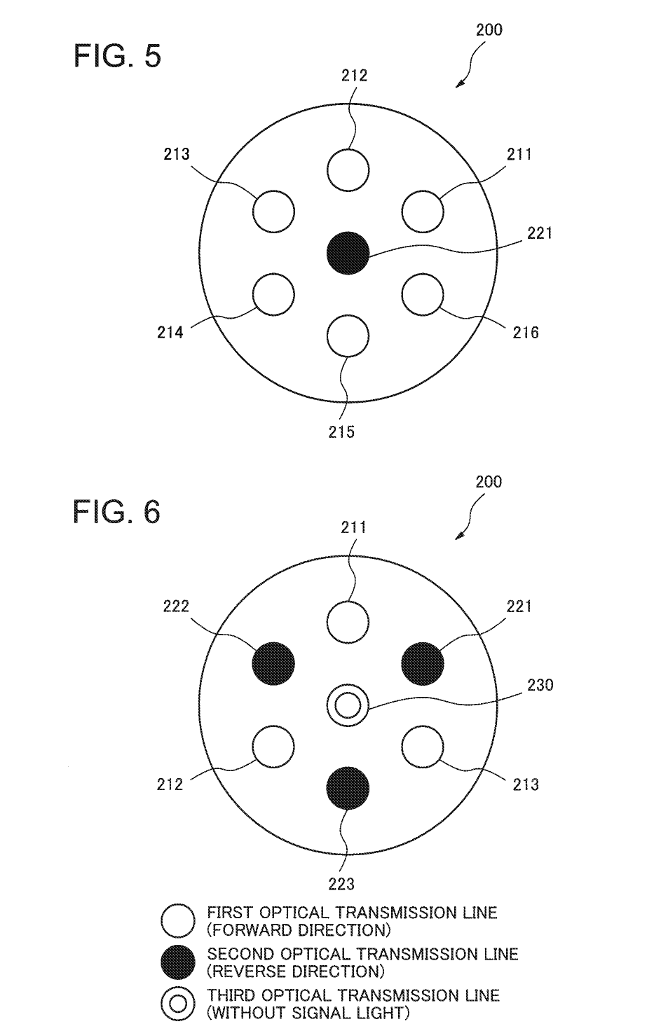

Next, the second exemplary embodiment of the present invention will be described. FIG. 5 is a cross-sectional view illustrating the configuration of a multiplexed optical transmission line in accordance with the second exemplary embodiment of the present invention. In the present exemplary embodiment, description will be made on a case using, as a multiplexed optical transmission line, a multicore optical fiber 200 in which cores as a plurality of optical transmission lines are arranged in a hexagonal close-packed structure.

Since the multicore optical fiber 200 includes many cores, there are many adjacent cores causing the crosstalk. FIG. 5 illustrates the multicore optical fiber 200 including seven cores. In this case, as the cores adjacent to the core 221 arranged centrally, there are a total of six cores, a core 211 to a core 216, which are circumferentially arranged. On the other hand, the cores adjacent to the core 212 for example which is one of the cores arranged circumferentially are a total of three cores, the core 221, the core 211, and the core 213. Therefore, in the configuration where all cores propagate signal light in the same direction, the signal light propagating through the central core 221 receives the largest deterioration by crosstalk.

On the other hand, in the multicore optical fiber 200 as the multiplexed optical transmission line in accordance with the present exemplary embodiment, the second optical transmission line is disposed in at least one of positions adjacent to the first optical transmission line wherever the first optical transmission line propagating the first signal light in the first direction may be disposed. The second optical transmission line propagates the second signal light in the second direction the reverse of the first direction. Such configuration can be realized in the double-layered, hexagonal close-packed structure illustrated in FIG. 5 by using the core 221 arranged centrally as the second optical transmission line and using the core 211 to the core 216 arranged circumferentially as the first optical transmission lines. Since this makes it possible to reduce the signal deterioration due to the crosstalk between cores, it is possible in an optical transmission system using a multicore optical fiber to realize a high-capacity transmission in which good signal quality is obtained.

It is possible to be configured so that the number of the first optical transmission lines which are disposed at positions adjacent to the first optical transmission line may be equal to or less than two wherever the first optical transmission line may be disposed. In the example illustrated in FIG. 5, for example, the first optical transmission lines propagating signals in the same direction for the core 212 as the first optical transmission line are the core 211 and the core 213, whose number is only two. In the configuration in which the core 221 arranged centrally in FIG. 5 is used as the first optical transmission line, the number of the first optical transmission line is zero which propagates signals in the same direction and is disposed at an adjacent position.

As mentioned above, when respective cores are disposed at the positions composing the hexagonal close-packed structure, the total number of the cores is an odd number. Therefore, when focusing on one certain core, all signal light propagating cores around the core propagates reversely, the propagation directions of the signal light cannot be divided equally, which causes the difference in the transmission possible capacity depending on the propagation direction.

However, that imbalance can be eliminated by adopting the configuration in which the number of the first optical transmission line is equal to that of the second optical transmission line, and a third optical transmission line without propagating signal light is further included. That is to say, the multicore optical fiber including N optical transmission lines (cores) in accordance with the present exemplary embodiment can be configured so that M lines of the first optical transmission lines and M lines of the second optical transmission lines may be included respectively, and the remainder of N−2×M lines may be used as the third optical transmission lines. The first optical transmission lines propagate the first signal light in the first direction, and the second optical transmission lines propagate the second signal light in the second direction opposite to the first direction.

It is possible to be configured so that at least one first optical transmission line and at least one second optical transmission line may be disposed at the positions adjacent to the third optical transmission line wherever the third optical transmission line may be disposed. This configuration makes it possible to reduce the deterioration of the signal quality due to the crosstalk between the optical transmission lines, and to have equal transmission possible capacity in both directions.

If the maximum value of the number of adjacent cores (generally, the number of adjacent cores of the core arranged centrally or near the center) in a multicore optical fiber is assumed to be K, it can be configured that the third optical transmission lines are disposed so that the number of the adjacent channels with the same propagation direction may be less than K/2 for all cores.

FIG. 6 illustrates a case applied to the multicore optical fiber 200 including seven cores arranged in the double-layered, hexagonal close-packed structure. It is configured so that a central core may be used as the third optical transmission line 230 without propagating signal light, and around the core, the first optical transmission lines 211 to 213 and the second optical transmission lines 221 to 223, whose propagation directions are different from each other, may be arranged alternately. This configuration makes it possible to equalize the transmission possible capacities because three cores are arranged for each propagation direction. Moreover, the configuration can be realized where cores with the same propagation direction, which cause the deterioration of the signal quality due to the crosstalk, do not lie next to each other. In FIG. 6, a double circle (⊚) represents the third optical transmission line without propagating signal light. A white circle (∘) represents the first optical transmission line propagating the first signal light in the first direction (forward direction), and a black circle () represents the second optical transmission line propagating the second signal light in the second direction (reverse direction) which is the opposite direction of the first direction.

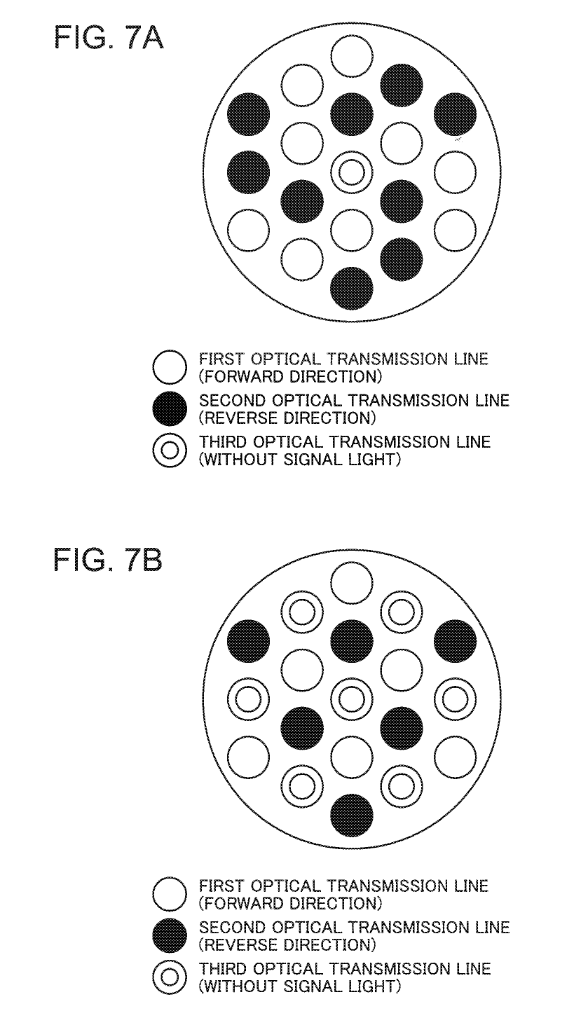

FIG. 7A and FIG. 7B illustrate cases applied to a multicore optical fiber 200 including nineteen cores arranged in the three-layered, hexagonal close-packed structure. In this case, as illustrated in FIG. 7A for example, it can be configured so that the central core only may be used as the third optical transmission line without propagating signal light, and the remainder of nine cores may be used as the first optical transmission lines and the second optical transmission lines. Since it is possible to be configured so that the number of the first optical transmission lines which are disposed at positions adjacent to the first optical transmission line may be equal to or less than two, it is possible to reduce the deterioration of the signal quality due to the crosstalk.

As illustrated in FIG. 7B, by using a total of seven cores including the central core as the third optical transmission lines, it can be configured so that the remainder of six cores may be used as the first optical transmission lines and the second optical transmission lines, respectively. In this case, since the number of the first optical transmission lines which are disposed at positions adjacent to the first optical transmission becomes zero, it is possible to further reduce the deterioration of the signal quality due to the crosstalk.

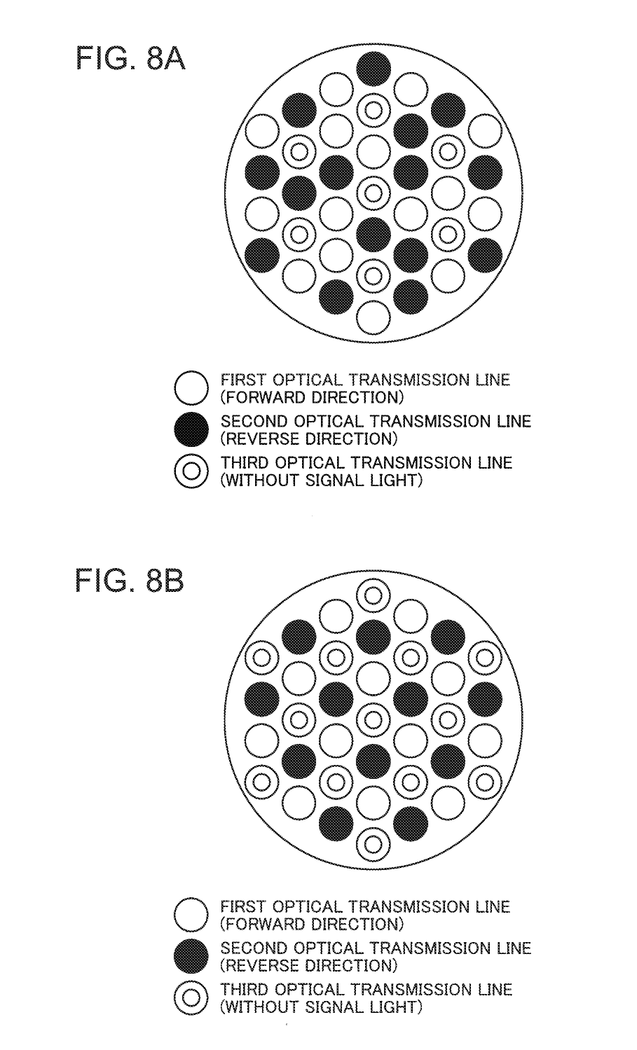

FIG. 8A and FIG. 8B illustrate cases applied to a multicore optical fiber 200 including thirty seven cores arranged in the four-layered, hexagonal close-packed structure. In this case, as illustrated in FIG. 8A for example, by using a total of seven cores including the central core as the third optical transmission lines without propagating signal light, it can be configured so that the remainder of fifteen cores may be used as the first optical transmission lines and the second optical transmission lines, respectively. Since this makes it possible to be configured so that the number of the first optical transmission lines which are disposed at positions adjacent to the first optical transmission line may be equal to or less than two, it is possible to reduce the deterioration of the signal quality due to the crosstalk.

As illustrated in FIG. 8B, by using a total of thirteen cores including the central core as the third optical transmission lines, it can be configured so that the remainder of twelve cores may be used as the first optical transmission lines and the second optical transmission lines, respectively. In this case, since the number of the first optical transmission lines which are disposed at positions adjacent to the first optical transmission becomes zero, it is possible to further reduce the deterioration of the signal quality due to the crosstalk.

The third optical transmission line can be configured to propagate control signal light having a different wavelength from any wavelength of the first signal light and the second signal light. This configuration makes it possible to monitor a loss of the transmission line constantly, for example.

Monitoring the loss of the transmission line is important for controlling the operation of an optical amplifier connected to the subsequent stage. Therefore, if an optical fiber with a single core is used, the monitoring is performed by using the intensity of the inputted signal light itself. However, since a crosstalk between cores can occur in a multicore optical fiber, it is difficult to determine whether the light having arrived at the optical amplifier in the subsequent stage is the signal light or the component having leaked from other cores. As a result, it is difficult to understand exactly the loss of the transmission line.

In contrast, according to the multicore optical fiber of the present exemplary embodiment, it is possible to use the third optical transmission line in order to monitor the loss of the transmission line. That is to say, it becomes possible to monitor the loss of the transmission line independently from transmitting the signal light by means of a dedicated core and a dedicated wavelength unaffected by the crosstalk.

According to an optical transmission method in accordance with the present exemplary embodiment, first, a third optical transmission line without propagating signal light is disposed. At this time, at least one first optical transmission line and at least one second optical transmission line are located at the positions adjacent to the third optical transmission line wherever the third optical transmission line may be disposed. In addition, it is possible to propagate control signal light having a different wavelength from any wavelength of the first signal light and the second signal light through the third optical transmission line. This makes it possible to reduce the deterioration of the signal quality due to the crosstalk between the optical transmission lines, and to have equal transmission possible capacity in both directions. In addition, it becomes possible to monitor a loss of the transmission line.

### The Third Exemplary Embodiment

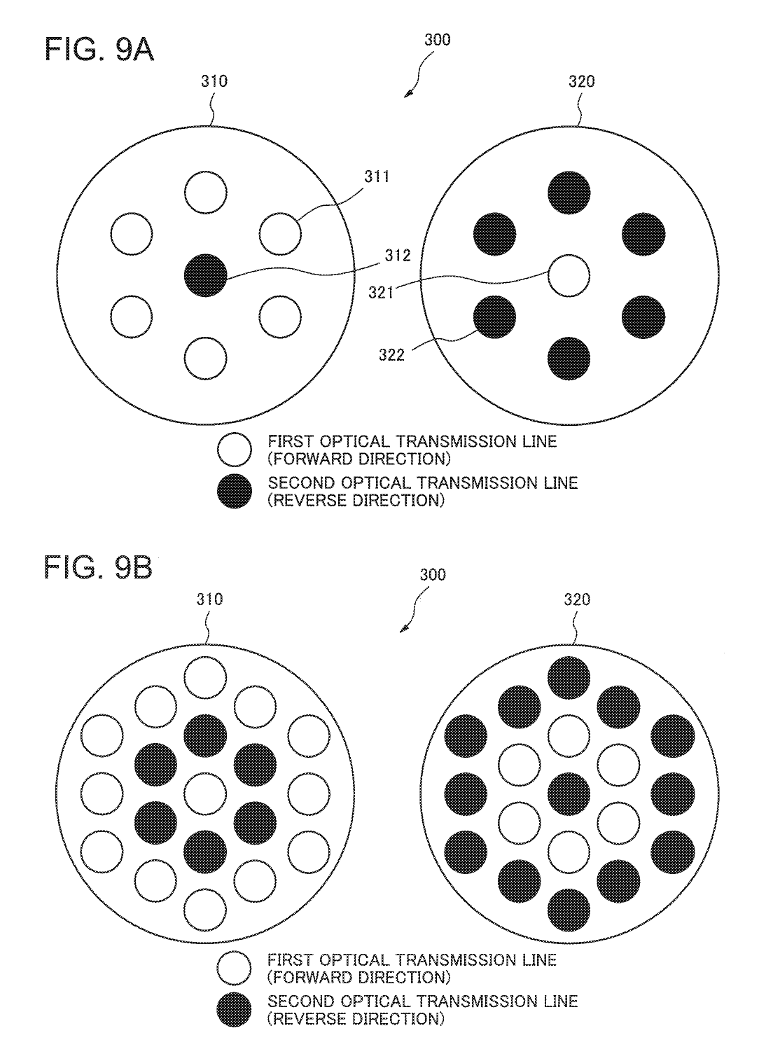

Next, the third exemplary embodiment of the present invention will be described. FIG. 9A and FIG. 9B are block diagrams illustrating the configuration a multiplexed optical transmission line 300 according to the third exemplary embodiment of the present invention. The multiplexed optical transmission line 300 includes a first multiplexed optical transmission line 310 and a second multiplexed optical transmission line 320.

As illustrated in FIG. 9A, each of the first multiplexed optical transmission line 310 and the second multiplexed optical transmission line 320 includes at least one first optical transmission line 311, 321 and at least one second optical transmission line 312, 322. The first optical transmission lines 311 and 321 propagate first signal light in a first direction. On the other hand, the second optical transmission lines 312 and 322 propagate second signal light 102 in a second direction opposite to the first direction. In FIG. 9A and FIG. 9B, white circles (∘) represent the first optical transmission lines 311 and 321, and black circles () represent the second optical transmission lines 312 and 322.

Each of the first multiplexed optical transmission line 310 and the second multiplexed optical transmission line 320 is configured to dispose the second optical transmission lines 312 and 322 in at least one of positions adjacent to the first optical transmission lines 311 and 321 wherever the first optical transmission lines 311 and 321 may be disposed.

In addition, with respect to the first multiplexed optical transmission line 310, the second optical transmission line 312 is disposed where the first optical transmission line 321 is disposed in the second multiplexed optical transmission line 320, and the first optical transmission line 311 is disposed where the second optical transmission line 322 is disposed in the second multiplexed optical transmission line 320. That is to say, the first multiplexed optical transmission line 310 and the second multiplexed optical transmission line 320 are configured symmetrically, and they compose the multiplexed optical transmission line 300 by forming a pair.

Specifically, with respect to a multicore optical fiber including N cores, the first multiplexed optical transmission line 310 is configured to dispose M lines of the first optical transmission lines and N-M lines of the second optical transmission lines depending on two propagation directions. On the other hand, the second multiplexed optical transmission line 320 is configured to dispose N-M lines of the first optical transmission lines and M lines of the second optical transmission lines at the corresponding placement points. It is configured so that equal number (N pieces) of the optical transmission lines (cores) may be disposed for each propagation direction by combining the first multiplexed optical transmission line 310 with the second multiplexed optical transmission line 320.

In addition, in an optical transmission method in accordance with the present exemplary embodiment, first, a first optical transmission line and a second optical transmission line are disposed so that the second optical transmission line may be located in at least one of positions adjacent to the first optical transmission line wherever the first optical transmission line may be disposed. Then, a fourth optical transmission line is disposed at a position symmetrical to the first optical transmission line, and a fifth optical transmission line is disposed at a position symmetrical to the second optical transmission line. The first signal light is propagated through the first optical transmission line and the fifth optical transmission line in the first direction. The second signal light is propagated through the second optical transmission line and the fourth optical transmission line in the second direction opposite to the first direction.

Next, the function and effect of the multiplexed optical transmission line 300 in accordance with the present exemplary embodiment will be described.

As described by using FIG. 5, if the propagation direction of the signal light is made reverse only for the central core, the number of the adjacent cores through which the signal light propagates in the same direction where a crosstalk can occur becomes zero for the central core and two for circumferential cores, and results in a significant reduction. However, in this case, six times difference arises between the transmission possible capacities in both directions.

In contrast, the multiplexed optical transmission line 300 in accordance with the present exemplary embodiment is configured to include two multicore optical fibers as the first multiplexed optical transmission line 310 and the second multiplexed optical transmission line 320. As illustrated in FIG. 9A, the number of the optical transmission lines (cores) through which the signal light propagates in both of the forward and reverse directions is six for the forward direction and one for the reverse direction in the first multiplexed optical transmission line 310. On the other hand, in the second multiplexed optical transmission line 320, the number is one for the forward direction and six for the reverse direction. This makes it possible for the multiplexed optical transmission line 300 to be configured to include the same number of the optical transmission lines for each propagation direction as a whole.

As described above, according to the present exemplary embodiment, it becomes possible to reduce the deterioration of the signal quality due to the crosstalk between the optical transmission lines, and to have equal transmission possible capacity in both directions.

FIG. 9B illustrates a case in which a multicore optical fiber including nineteen cores arranged in the three-layered, hexagonal close-packed structure is used for each of the first multiplexed optical transmission line 310 and the second multiplexed optical transmission line 320. In this case, with regard to the arrangement of cores, one core is arranged at the central, six in the second layer, and twelve in the third layer. The optical transmission lines (cores) through which the signal light propagates in both of the forward and reverse directions are disposed so that the first optical transmission line for the forward direction may be disposed at the center, the second optical transmission lines for the reverse direction at the second layer, and the first optical transmission lines for the forward direction at the third layer in the first multiplexed optical transmission line 310, for example. On the other hand, in the second multiplexed optical transmission line 320, so as to be symmetrical to the above arrangement, the second optical transmission line for the reverse direction is disposed at the center, the first optical transmission lines for the forward direction are disposed at the second layer, and the second optical transmission lines for the reverse direction are disposed at the third layer. This makes it possible for the multiplexed optical transmission line 300 to be configured to include the same number of the optical transmission lines for each propagation direction as a whole. Moreover, since it is possible to be configured so that the number of the first optical transmission lines which are disposed at positions adjacent to the first optical transmission line may be equal to or less than two, it is possible to reduce the deterioration of the signal quality due to the crosstalk.

It is also possible in the multiplexed optical transmission line 300 in accordance with the present exemplary embodiment to be configured to further include a third optical transmission line without propagating the signal light as is the case with the second exemplary embodiment. Here, each of the first multiplexed optical transmission line 310 and the second multiplexed optical transmission line 320 is a multicore optical fiber including N lines of optical transmission lines (cores). The first multiplexed optical transmission line 310 is configured to include M lines of the first optical transmission lines, L lines of the second optical transmission lines, and N−(M+L) lines of the third optical transmission lines. On the other hand, the second multiplexed optical transmission line 320 can be configured to include L lines of the first optical transmission lines, M lines of the second optical transmission lines, and N−(M+L) lines of the third optical transmission lines. Also in this case, it is possible to be configured to include equal number (M+L pieces) of the optical transmission lines (cores) for each propagation direction because the first multiplexed optical transmission line 310 and the second multiplexed optical transmission line 320 compose the multiplexed optical transmission line 300 by forming a pair.

The present invention is not limited to the aforementioned exemplary embodiments. Various modifications can be made therein within the scope of the present invention as defined by the claims, and obviously, such modifications are included in the scope of the present invention.

This application is based upon and claims the benefit of priority from Japanese Patent Application No. 2012-096896 filed on Apr. 20, 2012, the disclosure of which is incorporated herein in its entirety by reference.

### REFERENCE SIGNS LIST

100, 300 Multiplexed optical transmission line
101 First signal light
102 Second signal light
103, 503 Crosstalk component light
110, 211, 212, 213, 311, 321 First optical transmission line
120, 221, 222, 223, 312, 322 Second optical transmission line
200 Multicore optical fiber
211, 212, 213, 214, 215, 216, 221 Core
230 Third optical transmission line
310 First multiplexed optical transmission line
320 Second multiplexed optical transmission line
1000 Optical transmission system
1110, 5110 First optical transmitter
1120, 5120 First optical receiver
1210, 5210 Second optical transmitter
1220, 5220 Second optical receiver
5000 Optical transmission system using related multicore optical fiber
   10s First end
   20s Second end

What is claimed is:

1. A multiplexed optical transmission line, comprising:
at least one first optical transmission line propagating first signal light in a first direction; and
at least one second optical transmission line propagating second signal light in a second direction opposite to the first direction,
wherein the second optical transmission line is disposed in at least one of positions adjacent to the first optical transmission line wherever the first optical transmission line may be disposed.

2. The multiplexed optical transmission line according to claim 1,
wherein the number of the first optical transmission lines which are disposed at positions adjacent to the first optical transmission line is equal to or less than two wherever the first optical transmission line may be disposed.

3. The multiplexed optical transmission line according to claim 1,
wherein the number of the first optical transmission line is equal to the number of the second optical transmission line.

4. The multiplexed optical transmission line according to claim 1, further comprising a third optical transmission line without propagating signal light,
wherein at least one first optical transmission line and at least one second optical transmission line are disposed at the positions adjacent to the third optical transmission line wherever the third optical transmission line may be disposed.

5. The multiplexed optical transmission line according to claim 4,
wherein the third optical transmission line propagates control signal light having a different wavelength from any wavelength of the first signal light and the second signal light.

6. The multiplexed optical transmission line, comprising a first multiplexed optical transmission line and a second multiplexed optical transmission line of the multiplexed optical transmission line according to claim 1,
wherein in the first multiplexed optical transmission line, the second optical transmission line is disposed where the first optical transmission line is disposed in the second multiplexed optical transmission line, and the first optical transmission line is disposed where the second optical transmission line is disposed in the second multiplexed optical transmission line.

7. An optical transmission system, comprising:
a multiplexed optical transmission line;
a first optical transmitter and a first optical receiver connected to a first end of the multiplexed optical transmission line; and
a second optical transmitter and a second optical receiver connected to a second end on the side opposite to the first end of the multiplexed optical transmission line,
wherein the multiplexed optical transmission line comprises
at least one first optical transmission line propagating first signal light in a first direction; and
at least one second optical transmission line propagating second signal light in a second direction opposite to the first direction,
wherein the second optical transmission line is disposed in at least one of positions adjacent to the first optical transmission line wherever the first optical transmission line may be disposed,
wherein the first optical transmitter is connected to the first optical transmission line at the first end,
the second optical receiver is connected to the first optical transmission line at the second end,
the second optical transmitter is connected to the second optical transmission line at the second end, and
the first optical receiver is connected to the second optical transmission line at the first end.

8. An optical transmission method, comprising:
disposing at least one first optical transmission line and at least one second optical transmission line so as to locate the second optical transmission line in at least one of positions adjacent to the first optical transmission line wherever the first optical transmission line being disposed;
propagating first signal light in a first direction through the first optical transmission line; and
propagating second signal light in a second direction opposite to the first direction through the second optical transmission line.

9. The optical transmission method according to claim 8, further comprising:
disposing a third optical transmission line without propagating signal light so as to locate at least one first optical transmission line and at least one second optical transmission line at the positions adjacent to the third optical transmission line wherever the third optical transmission line being disposed; and
propagating control signal light having a different wavelength from any wavelength of the first signal light and the second signal light through the third optical transmission line.

10. The optical transmission method according to claim 8, further comprising:
disposing a fourth optical transmission line at a position symmetrical to the first optical transmission line;
disposing a fifth optical transmission line at a position symmetrical to the second optical transmission line;
propagating the first signal light through the first optical transmission line and the fifth optical transmission line in the first direction; and
propagating the second signal light through the second optical transmission line and the fourth optical transmission line in the second direction opposite to the first direction.

11. The multiplexed optical transmission line according to claim 2,
wherein the number of the first optical transmission line is equal to the number of the second optical transmission line.

12. The multiplexed optical transmission line according to claim 2, further comprising a third optical transmission line without propagating signal light,
wherein at least one first optical transmission line and at least one second optical transmission line are disposed at the positions adjacent to the third optical transmission line wherever the third optical transmission line may be disposed.

13. The multiplexed optical transmission line according to claim 12,
wherein the third optical transmission line propagates control signal light having a different wavelength from any wavelength of the first signal light and the second signal light.

14. The multiplexed optical transmission line according to claim 3, further comprising a third optical transmission line without propagating signal light,
wherein at least one first optical transmission line and at least one second optical transmission line are disposed at the positions adjacent to the third optical transmission line wherever the third optical transmission line may be disposed.

15. The multiplexed optical transmission line according to claim 14,
wherein the third optical transmission line propagates control signal light having a different wavelength from any wavelength of the first signal light and the second signal light.

16. The multiplexed optical transmission line, comprising a first multiplexed optical transmission line and a second multiplexed optical transmission line of the multiplexed optical transmission line according to claim 2,
wherein in the first multiplexed optical transmission line, the second optical transmission line is disposed where the first optical transmission line is disposed in the second multiplexed optical transmission line, and the first optical transmission line is disposed where the second optical transmission line is disposed in the second multiplexed optical transmission line.

17. The multiplexed optical transmission line, comprising a first multiplexed optical transmission line and a second multiplexed optical transmission line of the multiplexed optical transmission line according to claim 3,
wherein in the first multiplexed optical transmission line, the second optical transmission line is disposed where the first optical transmission line is disposed in the second multiplexed optical transmission line, and the first optical transmission line is disposed where the second optical transmission line is disposed in the second multiplexed optical transmission line.

18. The multiplexed optical transmission line, comprising a first multiplexed optical transmission line and a second multiplexed optical transmission line of the multiplexed optical transmission line according to claim 4,
wherein in the first multiplexed optical transmission line, the second optical transmission line is disposed where the first optical transmission line is disposed in the second multiplexed optical transmission line, and the first optical transmission line is disposed where the second optical transmission line is disposed in the second multiplexed optical transmission line.

19. The multiplexed optical transmission line, comprising a first multiplexed optical transmission line and a second multiplexed optical transmission line of the multiplexed optical transmission line according to claim 5,
wherein in the first multiplexed optical transmission line, the second optical transmission line is disposed where the first optical transmission line is disposed in the second multiplexed optical transmission line, and the first optical transmission line is disposed where the second optical transmission line is disposed in the second multiplexed optical transmission line.

20. The optical transmission method according to claim 9, further comprising:
disposing a fourth optical transmission line at a position symmetrical to the first optical transmission line;
disposing a fifth optical transmission line at a position symmetrical to the second optical transmission line;
propagating the first signal light through the first optical transmission line and the fifth optical transmission line in the first direction; and
propagating the second signal light through the second optical transmission line and the fourth optical transmission line in the second direction opposite to the first direction.
